(19) United States
(12) Patent Application Publication
(10) Pub. No.: US 2025/0183426 A1
(43) Pub. Date: Jun. 5, 2025

(54) MULTILAYER COMPOSITE STRUCTURE FOR PACKAGING LITHIUM ION BATTERY AND PREPARATION METHOD THEREOF AND LITHIUM ION BATTERY

(71) Applicant: SHENZHEN EPACKGING TECHNOLOGY CO., LTD., Shenzhen (CN)

(72) Inventors: Yuheng TANG, Shenzhen (CN); Yanpeng FENG, Shenzhen (CN)

(73) Assignee: SHENZHEN EPACKGING TECHNOLOGY CO., LTD., Shenzhen (CN)

(21) Appl. No.: 19/037,304

(22) Filed: Jan. 27, 2025

Related U.S. Application Data
(63) Continuation of application No. PCT/CN2023/124019, filed on Oct. 11, 2023.

(51) Int. Cl. H01M 50/141; H01M 10/0525; H01M 50/122; H01M 50/124

(52) U.S. Cl. CPC H01M 50/141; H01M 10/0525; H01M 50/122; H01M 50/124

(57) ABSTRACT

A multilayer composite structure for packaging a lithium ion battery and a preparation method thereof and a lithium ion battery are provided. The multilayer composite structure includes mutually-attached inner-layer connection layer film and outer-layer framework structure layer film, which both contain a water-blocking additive. In the existing external layered products, a composite structure of three or more layers is usually adopted, which includes an outer layer with high mechanical strength, a middle layer capable of preventing water vapor invasion, an inner layer having good thermal bonding performance, and a transition layer therebetween. The multilayer composite structure simplifies this structure, where a water-blocking additive is used to replace a metal aluminum foil to prevent invasion of the water vapor, and by using the characteristics of good compatibility of the outer layer and inner layer, the construction processes and costs are reduced, so as to increase to the safety performance.

### CROSS REFERENCE TO THE RELATED APPLICATIONS

This application is a continuation application of International Application No. PCT/CN2023/124019, filed on Nov. 10, 2023, which is based upon and claims priority to Chinese Patent Application No. 202211019003.0, filed on Aug. 24, 2022, the entire contents of which are incorporated herein by reference.

### TECHNICAL FIELD

The present disclosure relates to the field of new energy technologies and in particular to a multilayer composite structure for packaging a lithium ion battery and a preparation method thereof and a lithium ion battery.

### BACKGROUND

Lithium batteries (lithium secondary batteries) are batteries in which electrolyte is composed of a solid polymer, a gel polymer and a liquid and the like, and charge movement is generated by lithium ion movement, where cathode/anode active material is composed of a macromolecular polymer. The lithium secondary battery is composed of lithium battery bodies with the following components: cathode current collector material (aluminum and nickel)/cathode active substance layer (the cathode material includes, for example, a metal oxide, a carbon black, a metal sulfide, an electrolyte solution, and a polymer, for example, polypropylene)/electrolyte (carbonate electrolyte, for example, poly isopropenyl carbonate, ethylene carbonate, dimethyl carbonate and methyl ethylene carbonate, an inorganic solid electrolyte formed by lithium salt or gel electrolyte)/anode active substance layer (anode material, for example, lithium metal, alloy, carbon, electrolyte solution and polymer)/anode current collector material (copper, nickel, or stainless steel); and external jacket elements containing these elements. The lithium secondary batteries with high volumetric efficiency and high weight efficiency are widely applied to electronic devices, vehicles and miniature aircrafts. Especially, in the field of unmanned aerial vehicles, considerations for capacity and weight benefits are very significant. The existing lithium ion batteries cannot satisfy the requirements of the aircrafts for long-time operation.

For the layered products for packaging the lithium batteries, it is required to comprehensively consider the properties required for the lithium batteries, for example, vapor resistance, sealing performance, anti-perforation performance, insulation performance, heat resistance, cold resistance, electrolyte resistance (resistance to electrolyte solution) and corrosion resistance (resistance to corrosion of hydrofluoric acid generated by spoilage and hydrolysis of the electrolyte).

At present, the lithium ion batteries can be packaged in three ways: 1) soft packaging with aluminum plastic composite film: the aluminum plastic composite film structure can be formed into a proper shape fit for electronic devices or electronic part space, and thus the shapes of the electronic devices or electronic parts can be freely designed to some degree so as to realize miniaturization and light weight. The invention patent CN101087687A provides a secondary-battery outer-layer packaging material with aluminum plastic film structure. The packaging material involved in the patent has three major functional layers, where the outer layer is a polymer film made from PET, PEN or nylon to increase mechanical strength, the middle layer usually made from aluminum foil is mainly used to prevent water vapor infiltration, and the inner layer is used to provide good thermal sealing performance.

The layered structure of the existing layered products includes an outer basic layer, a middle aluminum foil layer and an inner layer. The aluminum foil used as the middle water-blocking layer can achieve good water-blocking effect but bring new problems. After the aluminum foil is added, it is necessary to solve the combination problem of the outer and inner layers and the metal water-blocking layer, so as to increase their combination strength. In the current practices, a thermal bonding resin with good bonding performance to the metal is added between the outer layer and the metal water-blocking layer, and the acid-modified, for example, unsaturated hydroxy acid-grafted-modified olefin resin is used in the inner layer of the layered products. For another example, the invention patent CN101087687A provides a chemical conversion layer formed by using a chemical conversion solution of aminated phenolic polymer, trivalent chromium compound and phosphorus compound, in order to improve the optimization of the bonding strength between the aluminum foil and the olefin resin layer having a bonding force to the metal.

The following problems are brought.

Problem 1: safety problem is introduced: the layer structure of the layered products is composed of a substrate layer, a metal foil, for example, a blocking layer made from aluminum and an inner layer, and a lithium hexafluorophosphate solution is used as an electrolyte solution in the lithium battery body and can react with moisture to produce hydrofluoric acid. The hydrofluoric acid can easily react with the aluminum foil and diffuse along the interface between the aluminum foil and the inner and outer layer and hence weaken the bonding force between the metal foil and the inner and outer structures, leading to peeling decomposition and shorter battery life.

Problem 2: short-circuit risk exists: when a metal connection terminal in the existing products is sealed, a thermal bonding manner is usually used. The metal connection terminal is sandwiched between the layered products. In a case of high calorie, the metal terminal comes in contact with the middle blocking layer made of metal aluminum foil in the layered products, leading to short-circuit problem. Further, when an external abnormal stress brings damage to the structure of the inner layer, micro cracks are formed on the surface of the inner layer and the liquid electrolyte invades into the blocking layer of the metal aluminum foil through the cracks. Due to high chemical activity of the aluminum metal, the function of the batteries will be damaged. The metal aluminum foil has high ductibility and machinability and can well prevent the invasion of external moisture and at the same time, bring the disadvantages of complex machining process, short-circuit risk of the batteries and high costs. Furthermore, the infiltration of the moisture from the bonding agent end surface of the inner layer is also obvious. In this case, the moisture infiltrating from the end surface penetrates into the inner layer to react with the electrolyte solution and produce hydrofluoric acid, leading to separation between the blocking layer made of the metal foil, for example, aluminum and the inner layer.

Problem 3: high construction costs: since the combination of the middle layer and the outer and inner layers of the current layered structure is bad, in order to improve their combination strength, it is necessary to introduce another processing technique and method, for example, chromium processing, to increase the surface activity of the blocking layer, thereby increasing the processing procedure and costs.

### SUMMARY

In order to solve the problems in the prior arts, the present disclosure provides a multilayer composite structure for packaging a lithium ion battery and a preparation method thereof and a lithium ion battery. Usually, the lithium ion battery includes an electrolyte, cathode and anode lead wires and external packaging. In the existing external layered products, a composite structure of three or more layers is usually adopted, which includes an outer layer with high mechanical strength, a middle layer capable of preventing water vapor invasion, an inner layer having good thermal bonding performance, and a transition layer therebetween. The object of the present disclosure is to simplify this structure so as to provide a multilayer composite structure, where a water-blocking additive is used to replace a metal aluminum foil to prevent invasion of the water vapor, and by using the characteristics of good compatibility of the outer layer and inner layer, the construction processes and costs are reduced, so as to increase to the safety performance.

A first object of the present disclosure is to provide a multilayer composite structure for packaging a lithium ion battery, which includes mutually-attached inner-layer connection layer film and outer-layer framework structure layer film, where the inner-layer connection layer film and the outer-layer framework structure layer film both contain a water-blocking additive.

In a preferred embodiment of the present disclosure,
the water-blocking additives in the inner-layer connection layer film and the outer-layer framework structure layer film are same or different, and may be independently at least one of an inorganic water-blocking agent, and an organic water-blocking agent;
the inorganic water-blocking agent preferably is at least one of titanium nitride, aluminum nitride, and a compound (Ti₂AlN) of nitrogen, aluminum and titanium; and/or,
the organic water-blocking agent preferably is at least one of perfluorinated compounds, and more preferably, is at least one of perfluorooctane sulfonate, perfluorooctanoic acid, and Teflon.

In a preferred embodiment of the present disclosure,
the inner-layer connection layer film is prepared by using mixing components including a thermal bonding polymer and the water-blocking additive, where the thermal bonding polymer preferably is at least one of polypropylene and modified polypropylene; the modified polypropylene preferably is at least one of ET20, ET70, ET80 manufactured by Japanese Okamoto Industries, Inc.; and/or,
the outer-layer framework structure layer film is prepared by mixing components including a high-melt-point polymer and the water-blocking additive, where the high-melt-point polymer is a polymer with a melt point between 200° C. and 350° C., preferably, is at least one of polyethylene terephthalate (PET) and nylon, and the nylon preferably is at least one of nylon 6, nylon 66.

In a preferred embodiment of the present disclosure,

The use amount of each component in the inner-layer connection layer film is calculated with the thermal bonding polymer as 100 parts by weight,
the water-blocking additive is 0.01 to 1 parts by weight, preferably is 0.06 to 0.8 parts by weight; and/or,
when the water-blocking additive is an inorganic water-blocking agent, the use amount preferably is 0.01 to 0.3 parts by weight, and more preferably, is 0.06 to 0.08 parts by weight; and/or,
when the water-blocking additive is an organic water-blocking agent, the use amount preferably is 0.1 to 1 parts by weight, and more preferably, is 0.2 to 0.8 parts by weight;
the use amount of each component in the outer-layer framework structure layer film is calculated with the high-melt-point polymer as 100 parts by weight,
the water-blocking additive is 0.01 to 1 parts by weight, and preferably, is 0.06 to 0.8 parts by weight; and/or,
when the water-blocking additive is an inorganic water-blocking agent, the use amount preferably is 0.01 to 0.3 parts by weight and more preferably, is 0.06 to 0.08 parts by weight; and/or,
when the water-blocking additive is an organic water-blocking agent, the use amount preferably is 0.1 to 1 parts by weight, and more preferably, is 0.2 to 0.8 parts by weight.

In a preferred embodiment of the present disclosure,
the inner-layer connection layer film and the outer-layer framework structure layer film further contain conventional toughening agent, nucleating agent, anti-oxidant, silicon oil, and modified aid in the prior arts, and their use amounts are also conventional amounts which can be used by those skilled in the arts based on actual situations.

The toughening agents in the inner-layer connection layer film and the outer-layer framework structure layer film are same or different, and may be independently and preferably at least one of maleic anhydride and polyolefin elastomer (POE); the polyolefin elastomer preferably is DOW 7457; and/or,
the nucleating agents in the inner-layer connection layer film and the outer-layer framework structure layer film are same or different, and preferably, are Miliken3988i; and/or,
the anti-oxidants in the inner-layer connection layer film and the outer-layer framework structure layer film are same or different, and preferably, are BASF Irgafos168; and/or,
the silicon oils in the inner-layer connection layer film and the outer-layer framework structure layer film are same or different, and preferably, are Dow Corning PMX-200; and/or,
the modified aids in the inner-layer connection layer film and the outer-layer framework structure layer film are same or different, and preferably, are LanxessMesamoll.

In the present disclosure, preferably, the use amount of each component in the inner-layer connection layer film is calculated with the thermal bonding polymer as 100 parts by weight,
thermal bonding polymer: 100 parts by weight;
toughening agent: 2 to 10 parts by weight; preferably 2 to 7 parts by weight;
nucleating agent: 1 to 3 parts by weight; preferably, 1.2 to 2 parts by weight;
anti-oxidant: 1 to 2 parts by weight; preferably, 1.2 to 1.5 parts by weight;
silicon oil: 0.2 to 0.5 parts by weight; preferably 0.3 to 0.4 parts by weight;
modified aid: 2 to 8 parts by weight; preferably, 3 to 5 parts by weight.

In the present disclosure, preferably, the use amount of each component in the outer-layer framework structure layer film is calculated with the high-melt-point polymer as 100 parts by weight,
high-melt-point polymer: 100 parts by weight;
toughening agent: 2 to 10 parts by weight; preferably, 2 to 7 parts by weight;
nucleating agent: 1 to 3 parts by weight; preferably, 1.2 to 2 parts by weight;
anti-oxidant: 1 to 2 parts by weight; preferably, 1.2 to 1.5 parts by weight;
silicon oil: 0.2 to 0.5 parts by weight; preferably, 0.3 to 0.4 parts by weight;
modified aid: 2 to 8 parts by weight; preferably, 3 to 5 parts by weight.

In a preferred embodiment of the present disclosure,
the total thickness of the multilayer composite structure is 50 to 200 μm, preferably, 80 to 150 μm; and/or, the thickness of the inner-layer connection layer film is 20 to 100 μm, and preferably, 40 to 80 μm; and/or, the thickness of the outer-layer framework structure layer film is 20 to 100 μm and preferably, 40 to 80 μm.

Compared with the conventional process, the total thickness of the multiplayer composite structure of the present disclosure is reduced, and under a same volume space condition, the volume density of the battery can be improved.

In a preferred embodiment of the present disclosure,
the multilayer composite structure further includes an intermediate water-blocking film and the material of the intermediate water-blocking film is at least one of titanium nitride, copper, polytetrafluoroethylene; the intermediate water-blocking film can further block invasion of the water vapor; and/or,
the thickness of the intermediate water-blocking film is in a range of 3 to 20 μm, and preferably, 3 to 10 μm.

When the material of the intermediate water-blocking film is polytetrafluoroethylene, the intermediate water-blocking film is moulded by extruding polytetrafluoroethylene. The extrusion moulding may be selected as conventional extrusion moulding process in the prior arts as long as the intermediate water-blocking film obtained by extrusion is in a range of 3 to 20 μm.

When the material of the intermediate water-blocking film is at least one of titanium nitride and copper, the intermediate water-blocking film is obtained by electrolessly plating or electro-plating at least one of titanium nitride and copper at a side of the inner-layer connection layer film attached to the outer-layer framework structure layer film or at a side of the outer-layer framework structure layer film attached to the inner-layer connection layer film. The electroless plating or electro-plating may be selected as conventional electroless plating or electroplating process in the prior arts as long as the intermediate water-blocking film obtained herein has a thickness of 3 to 20 m.

A second object of the present disclosure is to provide a preparation method for the multilayer composite structure for packaging a lithium ion battery as the first object of the present disclosure. The preparation method includes the steps of obtaining the multilayer composite structure by hot-pressing with double rollers the mutually-attached film layers including the inner-layer connection layer film and the outer-layer framework structure layer film.

In a preferred embodiment of the present disclosure,
the method includes:
obtaining the inner-layer connection layer film by melting, mixing, extruding and moulding the components including the thermal bonding polymer and the water-blocking additive; and/or,
obtaining the outer-layer framework structure layer film by melting, mixing, extruding and moulding the components including the high-melt-point polymer and the water-blocking additive.

The extrusion moulding of the inner-layer connection layer film and the outer-layer framework structure layer film can be carried out using the conventional extrusion moulding process in the prior arts as long as the film layers obtained by extrusion have a satisfactory thickness.

In a preferred embodiment of the present disclosure,
the temperature of the hot pressing by double rollers is in a range of 140 to 200° C., and preferably, 160 to 180° C., and its pressure is in a range of 1 to 3 MPa.

In the present disclosure, the following specific technical scheme is preferably selected:
firstly mixing thermal bonding polymer, water-blocking additive, toughening agent and silicon oil in a high-speed homogenizer, and then adding nucleating agent, anti-oxidant and modified aid and melting and mixing uniformly, and then extruding in a double-screw extruder and then casting along a metallic rotary drum to go through quenching setting, edge cutting, and take-up to produce the inner-layer connection layer film; wherein the extrusion process includes: drying temperature 120 to 140° C.; drying time: 0.1 to 5 hours; nozzle temperature: 240 to 280° C. (segmented control): first segment 240 to 280° C., second segment: 240 to 270° C., and third segment: 250 to 280° C.; pressure 5 to 10 MPa;
firstly mixing high-melt-point polymer, water-blocking additive, toughening agent and silicon oil in a high-speed homogenizer, then adding nucleating agent, anti-oxidant and modified aid and melting and mixing uniformly, then extruding in a double-screw extruder and then casting along a metallic rotary drum to go through quenching setting, edge cutting, and take-up to produce the outer-layer framework structure layer film; wherein the extrusion process includes: drying temperature 120 to 140° C.; drying time: 0.1 to 5 hours; nozzle temperature: 240 to 280° C. (segmented control): first segment 240 to 280° C., second segment: 240 to 270° C., and third segment: 250 to 280° C.; pressure 5 to 10 MPa;
attaching the film layers including the outer-layer framework structure layer film and the inner-layer connection layer film and as shown in FIG. 3, continuously running the outer-layer framework structure layer film and the inner-layer connection layer film containing the water-blocking additive through hot rollers to complete the moulding process and obtain a double-layer composite structure;
when the multilayer composite structure further includes an intermediate water-blocking film, placing the intermediate water-blocking film between the outer-layer framework structure layer film and the inner-layer connection layer film and then mutually attaching and then continuously running the outer-layer framework structure layer film, the intermediate water-blocking film and the inner-layer connection layer film through the hot rollers to complete the moulding process and obtain the multilayer composite structure containing the intermediate water-blocking film.

A third object of the present disclosure is to provide a lithium ion battery which is packaged using the multilayer composite structure of the first object of the present disclosure or using the multilayer composite structure prepared by using the method in the second object of the present disclosure.

The method of packaging using the multilayer composite structure of the present disclosure may be selected as the conventional packaging method in the prior arts. In the present disclosure, preferably, the multilayer composite structure is made into a rectangular groove structure with one end opening up (the opening end of the rectangular groove structure has an outer annular turn-up edge) and a groove cover structure matching the opening end of the rectangular groove structure, and then packaging is performed.

The present disclosure has the following beneficial effects.

The present disclosure makes improvement based on the existing aluminum plastic film layered structure, which improves the product reliability and reduces the costs while ensuring a full blocking performance. On the basis of the original structure of the conventional aluminum plastic film, the intermediate aluminum foil blocking layer is removed while relevant transition layer processing procedure is removed (the process for increasing the combination strength of the aluminum plastic film and the inner or outer layer). Furthermore, in order to improve the effect of blocking water vapor invasion, the method of adding a water-blocking additive between the inner and outer layers is used in the present disclosure so as to improve the effect of preventing the water vapor invading the internal electrolyte. Since the intermediate metal aluminum foil layer is removed, the multiplayer composite film can be prepared one time by using the hot pressing and moulding of double rollers.

In the present disclosure, the multilayer composite structure is prepared by using a water-blocking agent (water-blocking additive) to replace the metal foil water-blocking structure in the conventional aluminum plastic film. On the basis of ensuring the mechanical strength and electrolyte resistance, the construction method of changing the existing layered structure is used to achieve quick moulding of the multilayer film structure. Compared with the conventional method, in cooperation with the gridded vehicular chassis designing, the method can reduce the process difficulty and construction difficulty, and at the same time, can increase the thickness of a single cell to exceed the extreme thickness (10 mm) of the single cell packaged by aluminum plastic film. The thickness of the single cell using the multilayer composite structure of the present disclosure can reach 14 mm or more.

The multilayer composite structure of the present disclosure has good supporting strength and will not soft when packed into bags, facilitating injection of the electrolyte. Further, the present disclosure has extremely strong water-blocking capability and hence helps lower the requirements (air moisture) for the external environment during secondary packaging. The multilayer composite structure of the present disclosure has high mechanical strength, electrolyte solution resistance and thermal processing performance.

The multilayer composite structure of the present disclosure is applicable to packaging of vehicle batteries, energy storage batteries and two-wheel vehicle batteries (all are lithium ion batteries), but not applicable to packaging of miniature digital single cells.

### BRIEF DESCRIPTION OF THE DRAWINGS

FIG. 1 is a structural schematic diagram illustrating a multilayer composite structure without an intermediate water-blocking film according to the present disclosure, where 1 refers to an inner-layer connection layer film, and 2 refers to an outer-layer framework structure layer film.

FIG. 2 is a structural schematic diagram illustrating a multilayer composite structure with an intermediate water-blocking film according to the present disclosure, where 1 refers to an inner-layer connection layer film, 2 refers to an outer-layer framework structure layer film, and 3 refers to an intermediate water-blocking film.

FIG. 3 is a schematic diagram illustrating double-roller hot pressing and moulding process of a multilayer composite structure according to the present disclosure.

FIG. 4 is a schematic diagram illustrating a lithium ion battery using a multilayer film structure.

FIG. 5 is a schematic diagram illustrating a method of leading out an electrode of a lithium ion battery using a multilayer film structure.

FIG. 6 is a schematic diagram illustrating a moulding and processing method of a battery using a multilayer film structure.

FIG. 7 is a schematic diagram illustrating a moulding, hot pressing and sealing method of a battery using a multilayer film structure.

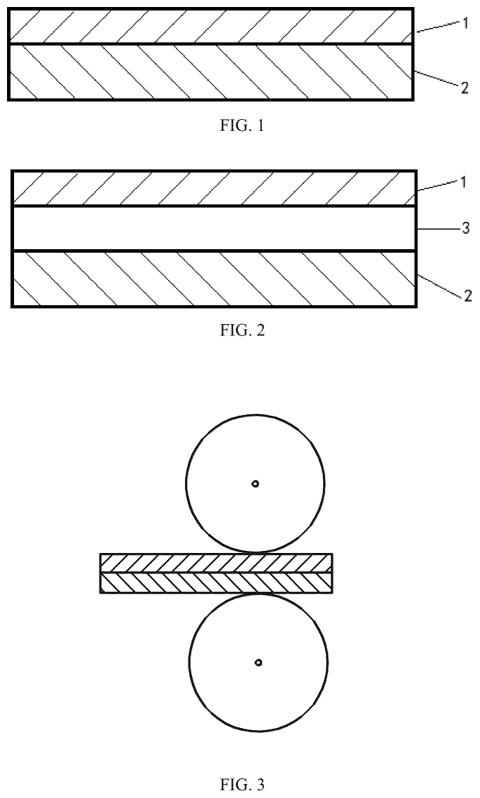

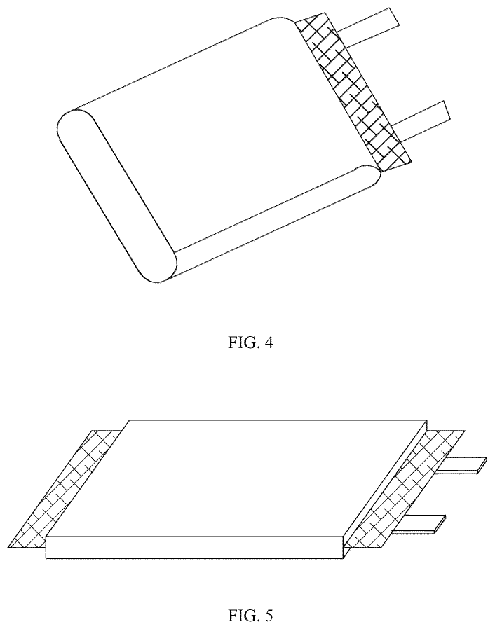

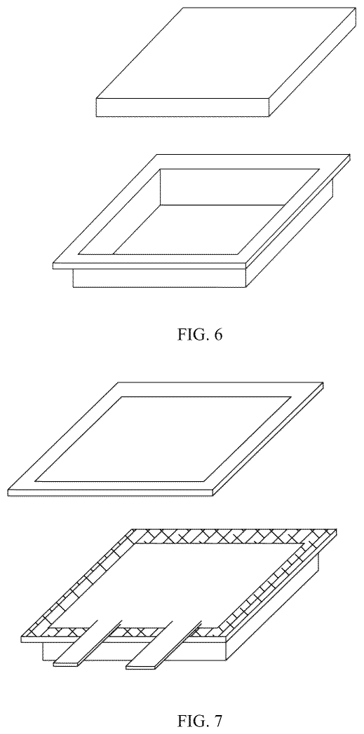

### DETAILED DESCRIPTION OF EMBODIMENTS

The present disclosure will be further detailed below in combination with specific embodiments and drawings. It is necessary to point out that the following embodiments are used only to further illustrate the present disclosure and shall not be understood as limiting of the present disclosure. Those non-essential improvements and adjustments made to the present disclosure by those skilled in the arts still fall within the scope of protection of the present disclosure.

The raw materials used in the embodiments and control embodiments are all commercially purchased.

The thickness measurement of the multilayer composite structure in the embodiments and control embodiments is carried out according to the standard GB/T6672-2001.

The test process of the electrolyte solution resistance: a multilayer composite structure sample is soaked in an electrolyte containing water of 200 ppm (the components of the electrolyte EMC:DMC:LIF6P=1:1:1) for 24 hours (the temperature 60° C.), and then the above sample is cut into a width of 15 mm and whether the sample can be peeled is determined by using a CTM8000 tensile tester under a pull force of ION. Testing whether the sample can be peeled by using the tensile tester can be carried out according to the standard GB/T 8808-1988.

The test process of the cracking resistance: the multilayer composite structure is hot-sealed and then placed into DZF6120 vacuum box to observe whether the product is cracked within 30 min under the pressure of 0.9 MPa.

The test process of the short-circuit resistance: BT5300 internal resistance tester is used, and the cathode is connected with the inner layer of the multilayer composite structure, and the anode is connected with outer layer of the multilayer composite structure, and then 500V voltage is applied to evaluate conduction time.

The test process of the water vapor transmission rate: the moisture transmission rate of the multilayer composite structure is tested by using a vapor transmission rate tester.

The test process of the moulding: the multilayer composite structure that has been cut is placed between a male die and a female die of the MSK-120 pouch battery integral moulding machine (housing length and width 100 mm*80 mm), and then the male die is heated to 100° C. and the female die is heated to 110° C.; then the multilayer composite structure is extruded and moulded with the moulding time of about 3 seconds and the holding time of about 6 seconds; cracking test is performed on the moulded multilayer composite structure using DZF6120 vacuum box under the pressure of 30 MPa to test an extreme moulding depth of the multilayer composite structure (i.e. the maximum moulding thickness of the multilayer composite structure during extrusion and moulding; the multilayer composite structure will not be cracked with this thickness but cracked once the thickness is exceeded).

### Embodiment 1

100 parts by weight of polypropylene (Yanshan Petrochemical K8303), 0.08 parts by weight of titanium nitride, 5 parts by weight of toughening agent (DOW 7457), 0.3 parts by weight of silicon oil were mixed in a high-speed homogenizer, and then 1.5 parts by weight of nucleating agent (Miliken3988i), 1.3 parts by weight of antioxidant (BASF Irgafos168) and 4 parts by weight of modified aid (LanxessMesamoll) were added, and then melted and uniformly mixed and then extruded in a double-screw extruder and then cast along a metallic rotary drum to go through quenching setting, edge cutting, and take-up to produce the inner-layer connection layer film; the extrusion process included: drying temperature 130° C.; drying time: 0.7 hours; nozzle temperature (segmented control): first segment 270° C., second segment: 250° C., and third segment: 270° C.; pressure 8.5 MPa;
100 parts by weight of PET (Shanghai Yuanfang CB-602), 0.07 parts by weight of titanium nitride, 5 parts by weight of toughening agent (DOW 7457) and 0.3 parts by weight of silicon oil were mixed in a high-speed homogenizer and then 1.5 parts by weight of nucleating agent (Miliken3988i), 1.3 parts by weight of antioxidant (BASF Irgafos168) and 4 parts by weight of modified aid (LanxessMesamoll) were added, and then melted and uniformly mixed and then extruded in a double-screw extruder and then cast along a metallic rotary drum to go through quenching setting, edge cutting, and take-up to produce the outer-layer framework structure layer film; the extrusion process included: drying temperature 130° C.; drying time: 0.7 hours; nozzle temperature (segmented control): first segment 270° C., second segment: 250° C., and third segment: 270° C.; pressure 8.5 MPa;
the above obtained outer-layer framework structure layer film and inner-layer connection layer film were attached to each other and then continuously run through hot rollers (temperature 170° C. and pressure 2 MPa) to produce the multilayer composite structure. In the multilayer composite structure, the thickness of the inner-layer connection layer film is 60 microns, and the thickness of the outer-layer framework structure layer film is 80 microns. The performances of the multilayer composite structure are indicated in Table 1.

### Embodiment 2

The preparation process of the embodiment 2 is same as that of the embodiment 1 except that 0.16 parts by weight of titanium nitride are added into the inner-layer connection layer film, and 0.14 parts by weight of titanium nitride are added into the outer-layer framework structure layer film. In the obtained multilayer composite structure, the thickness of the inner-layer connection layer film is 60 microns, and the thickness of the outer-layer framework structure layer film is 80 microns. The performances of the multilayer composite structure are indicated in Table 1.

### Embodiment 3

The preparation process of the embodiment 3 is same as that of the embodiment 2 except that an intermediate water-blocking film is added. The preparation process of the intermediate water-blocking film is as below: polytetrafluoroethylene (Zhejiang Juhua JTF-305) was melted and then extruded in a double-screw extruder and then cast along a metallic rotary drum to go through quenching setting, edge cutting, take-up to produce the intermediate water-blocking film; the extrusion process included: drying temperature 130° C.; drying time: 0.7 hours; nozzle temperature (segmented control): first segment 270° C., second segment: 250° C., and third segment: 270° C.; pressure 9 MPa.

In the obtained multilayer composite structure, the thickness of the inner-layer connection layer film is 60 microns, the thickness of the outer-layer framework structure layer film is 80 microns, and the thickness of the intermediate water-blocking film is 4 microns. The performances of the multilayer composite structure are indicated in Table 1.

### Embodiment 4

The preparation process of the embodiment 4 is same as that of the embodiment 1 except that the thickness of the inner-layer connection layer film in the obtained multilayer composite structure is 40 microns and the thickness of the outer-layer framework structure layer film is 60 microns. The performances of the multilayer composite structure are indicated in Table 1.

### Embodiment 5

The preparation process of the embodiment 5 is same as that of the embodiment 1 except that the thickness of the inner-layer connection layer film in the obtained multilayer composite structure is 40 microns and the thickness of the outer-layer framework structure layer film is 80 microns. The performances of the multilayer composite structure are indicated in Table 1.

### Control Embodiment 1

The preparation process of the control embodiment 1 is same as that of the embodiment 3 except that neither of the outer-layer framework structure layer film and inner-layer connection layer film contains a water-blocking additive. In the obtained multilayer composite structure, the thickness of the inner-layer connection layer film is 60 microns, the thickness of the outer-layer framework structure layer film is 80 microns, and the thickness of the intermediate water-blocking film is 4 microns. The performances of the multilayer composite structure are indicated in Table 1.

TABLE 1
Comparison of performances of the multilayer composite
structures in the embodiments and control embodiment

| | Resistance | | | | |
|---|---|---|---|---|---|
| | to | | Short circuit | Water vapor | |
| | electrolyte | Cracking | resistance | transmission | Mouldability |
| | solution | resistance | (sec) | rate (ppm) | (mm) |
| Embodiment 1 | No | No cracking | 15 | 40 | 18 |
| | peeling | | | | |
| Embodiment 2 | No | No cracking | 20 | 30 | 16 |
| | peeling | | | | |
| Embodiment 3 | No | No cracking | 22 | 28 | 14 |
| | peeling | | | | |
| Embodiment 4 | No | No cracking | 12 | 50 | 16 |
| | peeling | | | | |
| Embodiment 5 | No | No cracking | 14 | 48 | 17 |
| | peeling | | | | |
| Control embodiment 1 | Peeling | No cracking | 20 | 60 | 14 |
| Aluminum plastic film | Peeling | No cracking | 15 | — | 8 |
| (model Showa Denko | | | | | |
| C8, thickness 153 | | | | | |
| microns) | | | | | |

From the embodiments 1 to 5 and the control embodiment, it can be seen that compared with the aluminum plastic film in the prior arts, the multilayer composite structure in the present disclosure has excellent resistance to electrolyte solution, and due to hot pressing and moulding of double rollers, the moulding depth can reach 20 mm far greater than 8 mm reached by the aluminum plastic film. Further, the multilayer composite structure of the present disclosure also has good cracking resistance, short-circuit resistance and water vapor blocking performance, satisfying the use requirements. Since neither of the outer-layer framework structure layer film and inner-layer connection layer film contains a water-blocking additive in the control embodiment 1, its resistance to electrolyte solution and water vapor transmission rate are both inferior to those of the multilayer composite structure in the embodiments 1 to 5 in the present disclosure.

Therefore, it can be seen that, in the multilayer composite structure of the present disclosure, a water-blocking agent (water-blocking additive) is added to replace the metal foil water-blocking structure used in the conventional aluminum plastic film such that the construction method of the existing layered structure is changed on the basis of ensuring the mechanical strength and resistance to electrolyte solution, realizing quick moulding of the multilayer film structure.

What is claimed is:

1. A multilayer composite structure for packaging a lithium ion battery, comprising an inner-layer connection layer film and an outer-layer framework structure layer film, wherein the inner-layer connection layer film is mutually attached, and the inner-layer connection layer film and the outer-layer framework structure layer film both contain a water-blocking additive.

2. The multilayer composite structure of claim 1, wherein the water-blocking additives in the inner-layer connection layer film and the outer-layer framework structure layer film are same or different, and be independently at least one of an inorganic water-blocking agent and an organic water-blocking agent; wherein
the inorganic water-blocking agent is at least one of titanium nitride, aluminum nitride, and a compound of nitrogen, aluminum, and titanium; and/or,
the organic water-blocking agent is at least one of perfluorinated compounds, wherein the perfluorinated compounds comprise perfluorooctane sulfonate, perfluorooctanoic acid, and Teflon.

3. The multilayer composite structure of claim 1, wherein the inner-layer connection layer film is prepared by using mixing components comprising a thermal bonding polymer and the water-blocking additive, and the thermal bonding polymer is at least one of polypropylene and modified polypropylene; and/or,
the outer-layer framework structure layer film is prepared by mixing components comprising a high-melt-point polymer and the water-blocking additive, and the high-melt-point polymer is a polymer with a melt point between 200° C. and 350° C., wherein the polymer is at least one selected from polyethylene terephthalate (PET) and nylon.

4. The multilayer composite structure of claim 3, wherein a use amount of each component in the inner-layer connection layer film is calculated with the thermal bonding polymer as 100 parts by weight, and the water-blocking additive is 0.01 to 1 parts by weight; and/or,
a use amount of each component in the outer-layer framework structure layer film is calculated with the high-melt-point polymer as 100 parts by weight, and the water-blocking additive is 0.01 to 1 parts by weight.

5. The multilayer composite structure of claim 1, wherein a total thickness of the multilayer composite structure is 50 to 200 μm; and/or, a thickness of the inner-layer connection layer film is 20 to 100 μm.

6. The multilayer composite structure of claim 1, wherein the multilayer composite structure further comprises an intermediate water-blocking film and a material of the intermediate water-blocking film is at least one of titanium nitride, copper, and polytetrafluoroethylene; and/or, a thickness of the intermediate water-blocking film is in a range of 3 to 20 μm.

7. A preparation method for the multilayer composite structure of claim 1, comprising steps of obtaining the multilayer composite structure by hot-pressing with double rollers mutually-attached film layers comprising the inner-layer connection layer film and the outer-layer framework structure layer film.

8. The preparation method of claim 7, comprising:
obtaining the inner-layer connection layer film by melting, mixing, extruding, and moulding components comprising a thermal bonding polymer and the water-blocking additive; and/or,
obtaining the outer-layer framework structure layer film by melting, mixing, extruding, and moulding components comprising a high-melt-point polymer and the water-blocking additive.

9. The preparation method of claim 7, wherein
a temperature of the hot pressing by the double rollers is in a range of 140 to 200° C., and a pressure is in a range of 1 to 3 MPa.

10. A lithium ion battery, wherein the lithium ion battery is packaged using the multilayer composite structure of claim 1.

11. The preparation method of claim 7, wherein in the multilayer composite structure, the water-blocking additives in the inner-layer connection layer film and the outer-layer framework structure layer film are same or different, and be independently at least one of an inorganic water-blocking agent and an organic water-blocking agent; wherein
the inorganic water-blocking agent is at least one of titanium nitride, aluminum nitride, and a compound of nitrogen, aluminum, and titanium; and/or,
the organic water-blocking agent is at least one of perfluorinated compounds, wherein the perfluorinated compounds comprise perfluorooctane sulfonate, perfluorooctanoic acid, and Teflon.

12. The preparation method of claim 7, wherein in the multilayer composite structure, the inner-layer connection layer film is prepared by using mixing components comprising a thermal bonding polymer and the water-blocking additive, and the thermal bonding polymer is at least one of polypropylene and modified polypropylene; and/or,
the outer-layer framework structure layer film is prepared by mixing components comprising a high-melt-point polymer and the water-blocking additive, and the high-melt-point polymer is a polymer with a melt point between 200° C. and 350° C., wherein the polymer is at least one selected from polyethylene terephthalate (PET) and nylon.

13. The preparation method of claim 12, wherein in the multilayer composite structure, a use amount of each component in the inner-layer connection layer film is calculated with the thermal bonding polymer as 100 parts by weight, and the water-blocking additive is 0.01 to 1 parts by weight; and/or,
a use amount of each component in the outer-layer framework structure layer film is calculated with the high-melt-point polymer as 100 parts by weight, and the water-blocking additive is 0.01 to 1 parts by weight.

14. The preparation method of claim 7, wherein a total thickness of the multilayer composite structure is 50 to 200 μm; and/or, a thickness of the inner-layer connection layer film is 20 to 100 μm.

15. The preparation method of claim 7, wherein the multilayer composite structure further comprises an intermediate water-blocking film and a material of the intermediate water-blocking film is at least one of titanium nitride, copper, and polytetrafluoroethylene; and/or, a thickness of the intermediate water-blocking film is in a range of 3 to 20 μm.

16. The lithium ion battery of claim 10, wherein in the multilayer composite structure, the water-blocking additives in the inner-layer connection layer film and the outer-layer framework structure layer film are same or different, and be independently at least one of an inorganic water-blocking agent and an organic water-blocking agent; wherein
the inorganic water-blocking agent is at least one of titanium nitride, aluminum nitride, and a compound of nitrogen, aluminum, and titanium; and/or,
the organic water-blocking agent is at least one of perfluorinated compounds, wherein the perfluorinated compounds comprise perfluorooctane sulfonate, perfluorooctanoic acid, and Teflon.

17. The lithium ion battery of claim 10, wherein in the multilayer composite structure, the inner-layer connection layer film is prepared by using mixing components comprising a thermal bonding polymer and the water-blocking additive, and the thermal bonding polymer is at least one of polypropylene and modified polypropylene; and/or,
the outer-layer framework structure layer film is prepared by mixing components comprising a high-melt-point polymer and the water-blocking additive, and the high-melt-point polymer is a polymer with a melt point between 200° C. and 350° C., wherein the polymer is at least one selected from polyethylene terephthalate (PET) and nylon.

18. The lithium ion battery of claim 17, wherein in the multilayer composite structure, a use amount of each component in the inner-layer connection layer film is calculated with the thermal bonding polymer as 100 parts by weight, and the water-blocking additive is 0.01 to 1 parts by weight; and/or,
a use amount of each component in the outer-layer framework structure layer film is calculated with the high-melt-point polymer as 100 parts by weight, and the water-blocking additive is 0.01 to 1 parts by weight.

19. The lithium ion battery of claim 10, wherein a total thickness of the multilayer composite structure is 50 to 200 μm; and/or, a thickness of the inner-layer connection layer film is 20 to 100 μm.

20. The lithium ion battery of claim 10, wherein the multilayer composite structure further comprises an intermediate water-blocking film and a material of the intermediate water-blocking film is at least one of titanium nitride, copper, and polytetrafluoroethylene; and/or, a thickness of the intermediate water-blocking film is in a range of 3 to 20 μm.
